(19) United States
(12) Patent Application Publication
(10) Pub. No.: US 2026/0320038 A1
(43) Pub. Date: Oct. 15, 2026

(54) GENERATING QUERY LANGUAGE USING A GRAPH BASED INTERLINGUAL REPRESENTATION

(71) Applicant: International Business Machines Corporation, Armonk, NY (US)

(72) Inventors: Xiaokui Shu, Ossining, NY (US); Kevin Eykholt, White Plains, NY (US); Youngja Park, Princeton, NJ (US); Jiyong Jang, Chappaqua, NY (US)

(21) Appl. No.: 19/175,648

(22) Filed: Apr. 10, 2025

(51) Int. Cl. G06F 16/2452; H04L 9/40

(52) U.S. Cl. CPC G06F 16/24522; H04L 63/20

(57) ABSTRACT

A computer-implemented method for transforming natural language to a target query language for performing a cybersecurity task is provided. A processor set receives a request comprises natural language description of the cybersecurity task. The processor set converts the natural language description of the cybersecurity task into a graph using a machine learning model. The processor set translates the graph to a cybersecurity query in the target query language using a compiler. The processor set performs the cybersecurity task using the cybersecurity query on a cybersecurity platform that supports the target query language.

### BACKGROUND

The disclosure relates generally to generating query language from a natural language input using a graph based interlingual representation.

A query language is a structured, formalized language designed to retrieve, manipulate, and manage data within a database or an information system. Query languages such as SQL (Structured Query Language) or SPARQL (for semantic data queries) follow strict syntax and predefined rules that allow users or applications to request specific data efficiently. These languages are optimized for precision and clarity to ensure that computers can process queries unambiguously. In this case, query languages often require users to understand logical structures such as conditions, operators, and filters in order to extract relevant information accurately.

On the other hand, natural language refers to the way humans communicate, including spoken and written forms such as English and Spanish. Unlike query languages, natural language is inherently flexible, context-dependent, and often ambiguous. In this case, natural language relies on grammar, tone, and context to convey meaning. However, natural language is used for general communication and is not naturally structured for computational processing.

### SUMMARY

According to one illustrative embodiment, a computer-implemented method for transforming natural language to a target query language for performing a cybersecurity task is provided. A processor set receives a request comprising a natural language description of the cybersecurity task. The graph is generated based on an interlingual query language that defines node types for the graph. The processor set converts the natural language description of the cybersecurity task into a graph using a machine learning model. The processor set translates the graph to a cybersecurity query in the target query language using a compiler. The compiler is developed to understand syntax of both the interlingual query language and the target query language. The processor set performs the cybersecurity task using the cybersecurity query on a cybersecurity platform that supports the target query language. According to other illustrative embodiments, a computer system, and a computer program product for transforming natural language to a target query language for performing a cybersecurity task are also provided.

### BRIEF DESCRIPTION OF THE DRAWINGS

FIG. 1 is a pictorial representation of a computing environment in which illustrative embodiments may be implemented;

FIG. 2 is an illustration of a block diagram of a query management environment in accordance with an illustrative embodiment;

FIG. 3 is an illustration of a graph generated for transforming a natural language description to a target query language for performing a cybersecurity task in accordance with an illustrative embodiment;

FIG. 4 are illustrations of a graph generated for transforming a natural language description to a target query language for performing a cybersecurity task in accordance with an illustrative embodiment;

FIG. 5 is an illustration of a process for transforming a natural language description to a target query language for performing a cybersecurity task in accordance with an illustrative embodiment;

FIG. 6 is an illustration of a process for optimizing the cybersecurity query in accordance with an illustrative embodiment; and

FIG. 7 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one or more storage media (also called "mediums") collectively included in a set of one or more storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

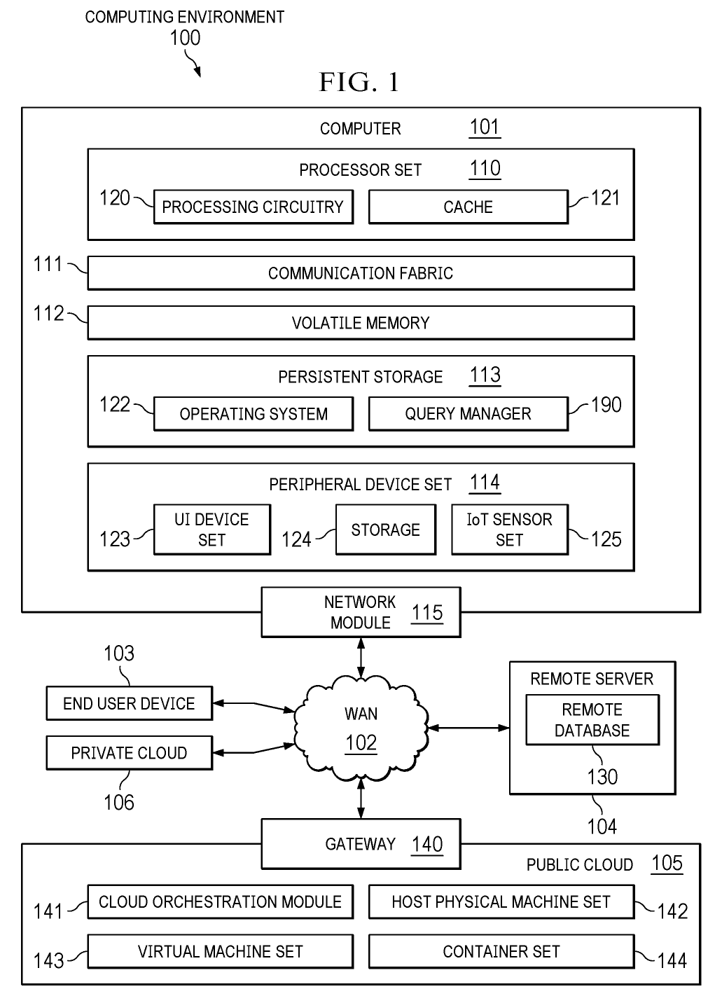

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as query manager 190. In addition to query manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and query manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in query manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in query manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that query languages are widely used in cybersecurity to access data, collect observations, perform investigations, and verify findings. The illustrative embodiments recognize and take into account that the variety in language syntax across products leads to a high learning overhead for security professionals to learn different query languages.

The illustrative embodiments recognize and take into account that current techniques to use large language models (LLM) for translating a natural language query directly to a target query language suffers from insufficient training data and data coverage. In addition, the illustrative embodiments also recognize and take into account that the accuracy of large language models primarily depends on the amount of training dataset and data coverage.

The illustrative embodiments also recognize and take into account that large language models may hallucinate outputs that do not align with the input and may contain irrelevant or impossible information.

Thus, illustrative embodiments of the present invention provide a computer implemented method, computer system, and computer program product for transforming a natural language description to a target query language for performing a cybersecurity task. A processor set receives a request comprising a natural language description of the cybersecurity task. The graph is generated based on an interlingual query language that defines nodes and edges for the graph. The processor set converts the natural language description of the cybersecurity task into a graph using a machine learning model. The processor set translates the graph to a cybersecurity query in the target query language using a compiler. The compiler is developed to understand the syntax of both the interlingual query language and the target query language. The processor set performs the cybersecurity task using the cybersecurity query on a cybersecurity platform that supports the target query language.

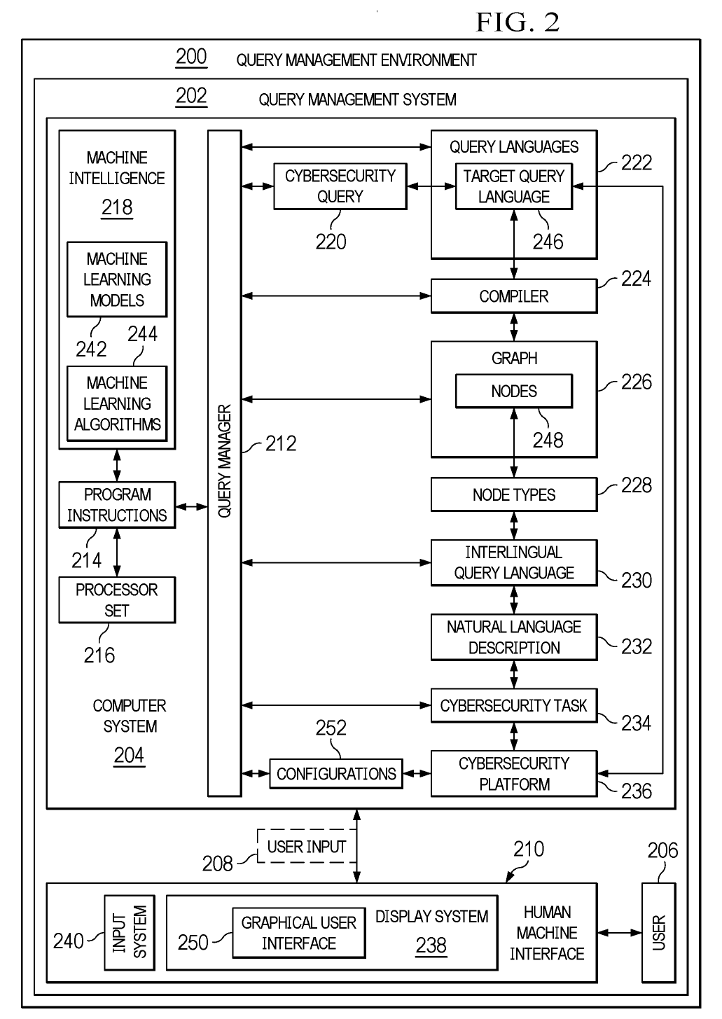

With reference now to FIG. 2, an illustration of a block diagram of a query management environment is depicted in accordance with an illustrative embodiment. In this illustrative example, query management environment 200 includes components that can be implemented in hardware such as the hardware shown in computing environment 100 in FIG. 1.

In this illustrative example, query management system 202 in query management environment 200 can be used to convert natural language description 232 of cybersecurity task 234 to cybersecurity query 220 based on target query language 246. In this illustrative example, query management system 202 includes computer system 204 which includes query manager 212. Query manager 212 is located in computer system 204. Query manager 212 may be implemented using query manager 190 in FIG. 1.

Query manager 212 can be implemented in software, hardware, firmware, or a combination thereof. When software is used, the operations performed by query manager 212 can be implemented in program instructions configured to run on hardware, such as a processor unit. When firmware is used, the operations performed by query manager 212 can be implemented in program instructions and data and stored in persistent memory to run on a processor unit. When hardware is employed, the hardware can include circuits that operate to perform the operations in query manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems. In this illustrative example, machine learning models 242 can include a number of large language models that are designed to understand, generate, and process human language. Machine learning models 242 and machine learning algorithms 244 may make computer system 204 a special purpose computer for converting natural language description of a cybersecurity task to a cybersecurity query in a target query language.

Machine learning models 242 involves using machine learning algorithms 244 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 244 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest. In addition, machine learning algorithms 244 can also include semi-supervised learning which necessitates human involvement for input validations.

As depicted, query manager 212 can receive natural language description 232 of cybersecurity task 234 that is to be performed in cybersecurity platform 236 based on a user input from a user. In this illustrative example, cybersecurity task 234 is an action or procedure used for protecting digital systems, networks, and data in computer system 204 from cyber threats. Cybersecurity task 234 can be a wide range of tasks that protect computer system 204 from cyber threats. Cybersecurity task 234 can range from identifying vulnerabilities in computer system 204 to implementing security measures that prevent unauthorized access to computer system 204. For example, cybersecurity task 234 can be a task for monitoring network traffic for suspicious activity, conducting penetration testing to find weaknesses, and applying security patches to software.

In this illustrative example, natural language description 232 includes content or description of cybersecurity task 234 that needs to be performed in cybersecurity platform 236. Cybersecurity platform 236 is a system designed to protect digital assets, networks, and sensitive data from cyber threats. Cybersecurity platform 236 integrates security tools and technologies to provide real-time threat detection, prevention, and response. For example, cybersecurity platform 236 can include features such as firewalls, intrusion detection and prevention systems (IDPS), endpoint security, encryption, threat intelligence, as well as advanced analysis and response capabilities such as event logging, security datalake, and threat hunting to safeguard against malware, phishing, ransomware, and other cyberattacks.

In this illustrative example, query manager 212 uses machine learning models 242 from machine intelligence 218 to generate interlingual query language 230 based on a number of query languages 222. In this illustrative example, interlingual query language 230 is a standardized language or framework designed to facilitate queries across multiple query languages and systems. Interlingual query language 230 can be a graph representation that acts as an intermediary between natural languages and a number of query languages 222. In this illustrative example, examples of query languages 222 can include SQL query languages and NoSQL query languages.

In this illustrative example, machine learning models 242 such as large language models (LLMs) translate natural language description 232 to a graph based on interlingual query language 230 with a standardized schema. The LLMs in this step can be extended into an agent to handle issues such as abstract concepts in natural language.

Machine learning models 242 such as LLMs can be prompt-tuned or fine-tuned for the interlingual query language 230. In this illustrative example, the LLMs can be modified, for example, by swapping the last softmax layer with a graph generation layer to directly generate graphs of specific sets of nodes instead of tokens.

In this illustrative example, query manager 212 uses machine learning models 242 to define a graph structure for interlingual query language 230 based on the number of query languages 222. In this example, query manager 212 can use the number of machine learning models 242 to define node types 228 for the graph structure of interlingual query language 230. In this illustrative example, each node type from node types 228 defines a portion of workflow for performing a cybersecurity task, or an action that can be performed using the number of query languages 222.

In this illustrative example, node types 228 can include the node types abstracted from commonly used query languages for cybersecurity such as SQL, Kusto Query Language (KQL), and XML Query Language (XQL). For example, node types 228 can include “DataSource”, “Variable”, “ProjectEntity”, “ProjectAttributes”, “Filter”, “Limit”, “Offset”, “Sort”, “Group”, or any other actions or representations that can be abstracted from the number of query languages 222.

In this illustrative example, query manager 212 uses interlingual query language 230 and node types 228 for interlingual query language 230 to generate graph 226 for natural language description 232 of cybersecurity task 234. In this illustrative example, graph 226 includes a number of nodes 248 based on node types 228 and each node from the number of nodes 248 represents an action or portion of a workflow for performing cybersecurity task 234. In other words, graph 226 is a representation of interlingual query generated by connecting the number of nodes 248 that represent actions or portions of the workflow for performing cybersecurity task 234. In this illustrative example, a standard cybersecurity telemetry schema can be used for object and attribute representation by interlingual query language 230. For example, the process object and entity in Open Cybersecurity Schema Framework (OCSF) object schema can be used for object and attribute representation by interlingual query language 230.

In this illustrative example, nodes 248 represents at least one of query stages, data values, query functions, or query object.

In this illustrative example, query manager 212 uses compiler 224 to ingest graph 226 for generating cybersecurity query 220 in target query language 246. In this illustrative example, compiler 224 is a software program that translates code written in one language to another language. In this illustrative example, compiler 224 is developed to translate graphs such as graph 226 represented in interlingual query language 230 to a cybersecurity query such as cybersecurity query 220 in a deterministic manner.

In this example, the development of compiler 224 requires the understanding of the syntax of both interlingual query language 230 and target query language 246, but not the data schema and value distribution of target query language 246, which vary in different execution environments.

In this illustrative example, compiler 224 is paired with entity and attribute mapping from the standardized schema to specific query environment such as cybersecurity platform 236 for operation. The configuration and mapping development requires the understanding of target query language 246 in a specific environment such as cybersecurity platform 236. In this example, query manager 212 generates configurations 252 based on the entity and attribute mapping from the standardized schema to cybersecurity platform 236. Configurations 252 can be used as input for compiler 224.

In this illustrative example, compiler 224 can further perform grammar checking, optimization, and security policy enforcement when generating cybersecurity query 220. For example, the node of table creation is not allowed in the target environment such as cybersecurity platform 236, or the edge from a specific type of Variable node to a ProjectEntity node from the number of nodes 248 is not allowed in the target environment.

As a result, query manager 212 generates cybersecurity query 220 in target query language 246 for performing cybersecurity task 234 in cybersecurity platform 236 based on natural language description 232 for cybersecurity task 234.

In this illustrative example, user 206 can interact with computer system 204 via user input 208. User input 208 can be generated by user 206 using human machine interface (HMI) 210. For example, user 206 can provide natural language description 232 of cybersecurity task 234 to computer system 204 via user input 208. As depicted, human machine interface 210 includes display system 238 and input system 240. Display system 238 is a physical hardware system and includes one or more display devices on which graphical user interface 250 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, virtual reality headsets, or some other suitable device that can output information for the visual presentation of information.

In this example, user 206 is a person that can interact with graphical user interface 250 through user input 208 generated by input system 240. Input system 240 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. In this illustrative example, user 206 can view cybersecurity query 220, graph 226, and natural language description 232 through graphical user interface 250.

In one illustrative example, one or more solutions are present that overcome a problem with converting a natural language description of a cybersecurity task to a cybersecurity query in a specific target query language. As a result, one or more technical solutions may provide an ability to increase the efficiency for converting a natural language description of a cybersecurity task to a cybersecurity query in a specific target query language. In this illustrative example, converting natural language to a query language enables more intuitive and user-friendly interaction with databases, search engines, and artificial intelligence systems. Traditional query languages, such as SQL or SPARQL, require structured syntax, which can be complex for non-technical users. By allowing users to input queries in natural language, systems can process and convert them into structured queries, reducing the need for technical expertise. This approach improves accessibility, allowing business analysts, researchers, and general users to retrieve data efficiently without learning complex query syntax.

Additionally, combining natural language processing (NLP) techniques with query conversion can enhance automation and intelligence in software applications. AI-driven chatbots, virtual assistants, and search engines can interpret user intent, generate appropriate queries, and fetch accurate results in real time. This leads to more dynamic and interactive applications where users can interact naturally without rigid command structures. Moreover, software systems benefit from improved error handling, as NLP models such as LLMs can understand variations in phrasing, detect ambiguities, and refine queries for better accuracy.

Further, converting natural language to query language enhances efficiency in data processing and computing resource utilization. Hardware systems, such as embedded databases, IoT devices, and edge computing units, often have limited computational power. By translating natural language input into optimized query commands, these systems can process requests more efficiently with minimal resource consumption. This reduces latency, as structured queries are easier to execute compared to raw natural language processing at the hardware level.

Another significant benefit is integration with specialized hardware accelerators, such as GPUs and TPUs, which are optimized for handling structured query operations. When natural language queries are converted into optimized database queries, processing can be offloaded to specialized hardware that leads to faster response times and improved scalability. In large-scale distributed computing environments such as cloud databases and big data processing clusters, structured queries enable more efficient indexing, retrieval, and analysis, ensuring optimal hardware utilization and system performance.

In the illustrative example, computer system 204 can be configured to perform at least one of the steps, operations, or actions described in the different illustrative examples using software, hardware, firmware, or a combination thereof. As a result, computer system 204 operates as a special purpose computer system in which query manager 212 in computer system 204 enables conversion of a user query in natural language to a cybersecurity query for performing a cybersecurity task in a cybersecurity platform. In particular, query manager 212 transforms computer system 204 into a special purpose computer system as compared to currently available general computer systems that do not have query manager 212.

The illustration of query management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, new query language can be added to query languages 222 and interlingual query language 230 can be subsequently updated to account for the new query language such that conversion between natural language of a cybersecurity query to a cybersecurity query in the new query language is enabled. In an alternative illustrative example, interlingual query language 230 can further define edge types for graph 226 along with node types 228. In this example, edge types for graph 226 define query structure for converting natural language description 232 of cybersecurity task 234 to cybersecurity query 220.

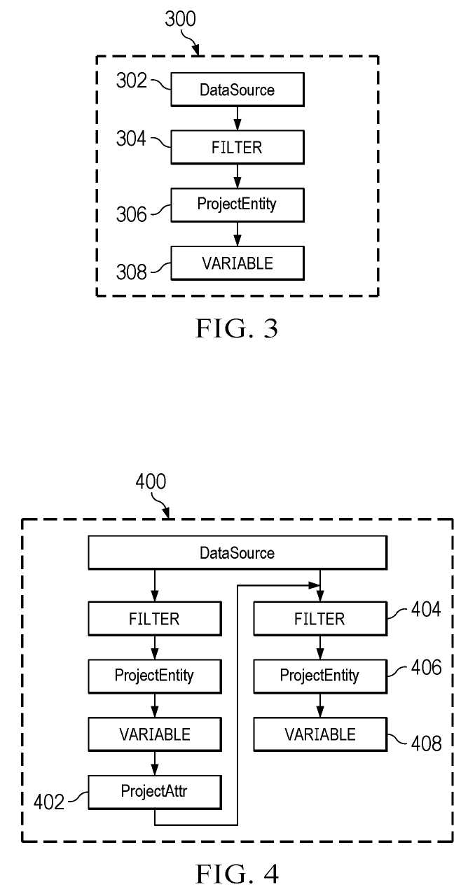

With reference now to FIG. 3, a diagram illustrating a graph generated for transforming natural language to a target query language for performing a cybersecurity task is shown in accordance with an illustrative embodiment. In this illustrative example, graph 300 can be an example of graph 226 in FIG. 2.

In this illustrative example, graph 300 can be generated by a machine learning model such as machine learning models 242 in FIG. 2 based on a natural language description of “search for all processes that has ‘##WID\tsql\query’ in their command line” for a cybersecurity task. In this example, graph 300 defines logic and workflows for performing the task according to the natural language description for the cybersecurity task. For example, node 302 defines the first step for performing the task. In this example, node 302 has a node type of “DataSource” which defines which data source such as data lake, table, and index to search.

In this illustrative example, node 304 has a node type of “filter” and defines expression in Open Cybersecurity Schema Framework (OCSF) for the filtering criteria as “process.cmd_line LIKE "##WID\tsql\query". Subsequently, node 306 has a node type of “ProjectEntity” that defines what type of output will be returned. In this example, node 308 has a node type of “Variable” that reference to the cached output returned, which can be used in future investigation.

In this illustrative example, graph 300 can be used by a compiler such as compiler 224 in FIG. 2 for converting the natural language description of the cybersecurity task to a target query language such as SQL.

With reference now to FIG. 4, a diagram illustrating a graph generated for transforming natural language to a target query language for performing a cybersecurity task is shown in accordance with an illustrative embodiment. In this illustrative example, graph 400 can be an example of graph 226 in FIG. 2.

In this illustrative example, graph 300 can be generated by a machine learning model such as machine learning models 242 in FIG. 2 based on a natural language description of “Search for files that are created by processes that has “##WID\tsql\query” in their command line” for a cybersecurity task. In this example, graph 400 defines logic and workflows for performing the task according to the natural language description for the cybersecurity task. As depicted in graph 400, more nodes are added on top of the workflow defined by graph 300 in FIG. 3 to define additional workflows to search for files that are created by processes identified from workflows defined by graph 300.

In FIG. 4, node 402 has a node type of “ProjectAttr” which defines identifiers for object type “process”. Subsequently, node 404 has a node type of “Filter” and defines a step of tracking files that are created by the processes identified from node 402. In an alternative example, node 404 can take inputs from node “DataSource” and directly identifies files created by processes that contain “##WID\tsql\query” in their command line.

In this illustrative example, node 406 has a node type of “ProjectEntity” that defines the step of extracting file objects. As a result, node 408 has a node type of “Variable” that reference to the cached output returned, which can be used in future investigation.

In a similar fashion, graph 400 can be used by a compiler such as compiler 224 in FIG. 2 for converting the natural language description of “search for files that are created by processes that contain ‘##WID\tsql\query’ in their command line” to a target query language such as SQL.

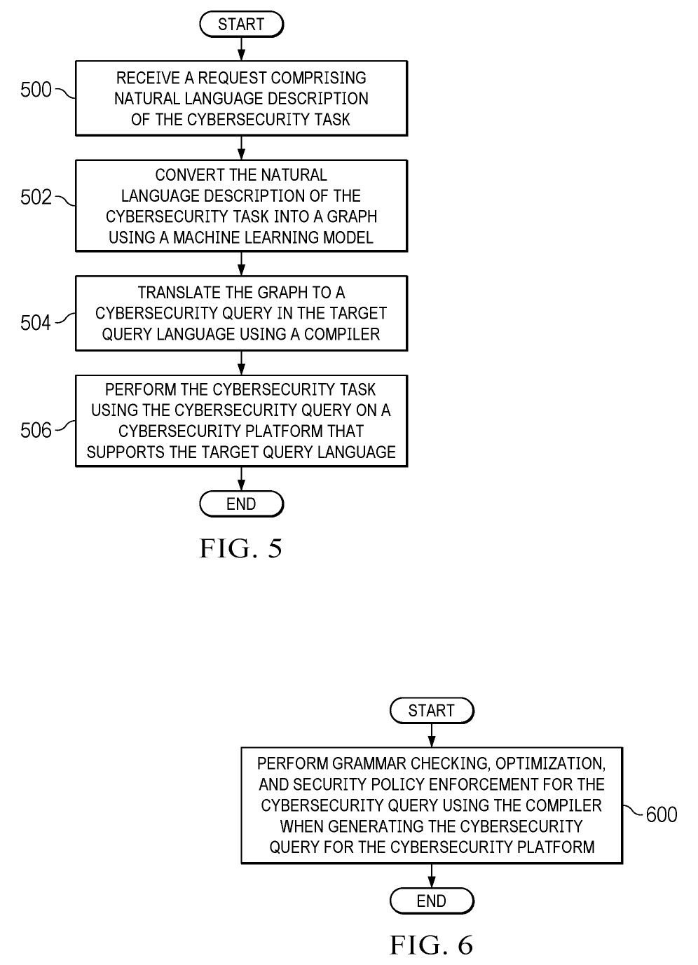

With reference now to FIG. 5, a flowchart illustrating a process for transforming natural language to a target query language for performing a cybersecurity task is shown in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in data transmission manager 212 in computer system 204 in FIG. 2.

The process begins by receiving a request comprising natural language description of the cybersecurity task (step 500). The process converts the natural language description of the cybersecurity task into a graph using a machine learning model (step 502). The graph is generated based on an interlingual query language that defines node types for the graph. The process translates the graph to a cybersecurity query in the target query language using a compiler (step 504). The compiler is developed to understand syntax of both the interlingual query language and the target query language. The process performs the cybersecurity task using the cybersecurity query on a cybersecurity platform that supports the target query language (step 506). The process terminates thereafter.

Turning next to FIG. 6, a flowchart of a process for optimizing the cybersecurity query is depicted in accordance with an illustrative embodiment. The process in this figure is an example of an additional step that can be performed with the steps in FIG. 5.

The process begins by performing grammar checking, optimization, and security policy enforcement for the cybersecurity query using the compiler when generating the cybersecurity query for the cybersecurity platform (step 600). The process terminates thereafter.

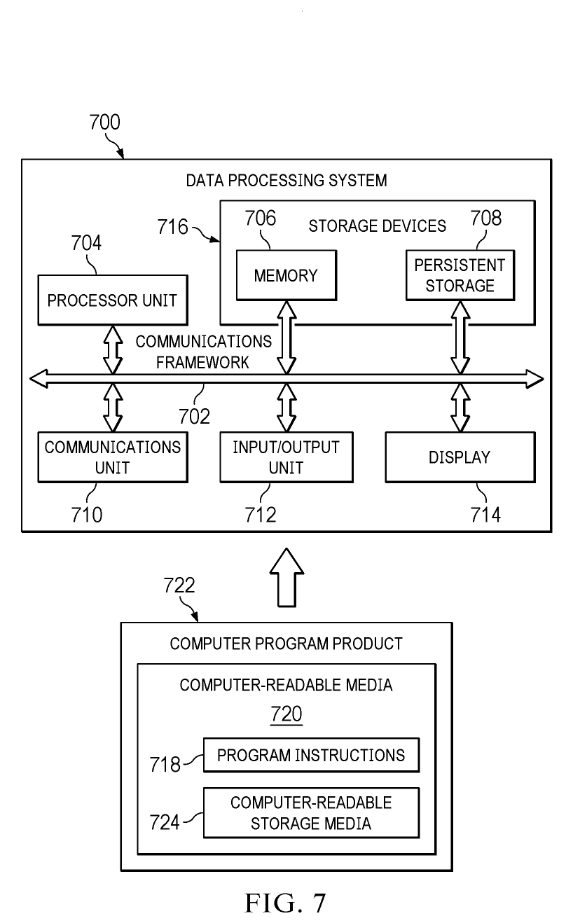

Turning now to FIG. 7, a block diagram of a data processing system is depicted in accordance with an illustrative embodiment. Data processing system 700 can be used to implement computers and computing devices in computing environment 100 in FIG. 1. Data processing system 700 can also be used to implement computer system 204 in FIG. 2. In this illustrative example, data processing system 700 includes communications framework 702, which provides communications between processor unit 704, memory 706, persistent storage 708, communications unit 710, input/output (I/O) unit 712, and display 714. In this example, communications framework 702 takes the form of a bus system.

Processor unit 704 serves to execute instructions for software that can be loaded into memory 706. Processor unit 704 includes one or more processors. For example, processor unit 704 can be selected from at least one of a multicore processor, a central processing unit (CPU), a graphics processing unit (GPU), a physics processing unit (PPU), a digital signal processor (DSP), a network processor, or some other suitable type of processor. Further, processor unit 704 can be implemented using one or more heterogeneous processor systems in which a main processor is present with secondary processors on a single chip. As another illustrative example, processor unit 704 can be a symmetric multi-processor system containing multiple processors of the same type on a single chip.

Memory 706 and persistent storage 708 are examples of storage devices 716. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 716 may also be referred to as computer-readable storage devices in these illustrative examples. Memory 706, in these examples, can be, for example, a random-access memory or any other suitable volatile or non-volatile storage device. Persistent storage 708 may take various forms, depending on the particular implementation.

For example, persistent storage 708 may contain one or more components or devices. For example, persistent storage 708 can be a hard drive, a solid-state drive (SSD), a flash memory, a rewritable optical disk, a rewritable magnetic tape, or some combination of the above. The media used by persistent storage 708 also can be removable. For example, a removable hard drive can be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that can be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs can be located in storage devices 716, which are in communication with processor unit 704 through communications framework 702. The processes of the different embodiments can be performed by processor unit 704 using computer-implemented instructions, which may be located in a memory, such as memory 706.

These instructions are referred to as program instructions, computer usable program instructions, or computer-readable program instructions that can be read and executed by a processor in processor unit 704. The program instructions in the different embodiments can be embodied on different physical or computer-readable storage media, such as memory 706 or persistent storage 708.

Program instructions 718 are located in a functional form on computer-readable media 720 that is selectively removable and can be loaded onto or transferred to data processing system 700 for execution by processor unit 704. Program instructions 718 and computer-readable media 720 form computer program product 722 in these illustrative examples. In the illustrative example, computer-readable media 720 is computer-readable storage media 724.

Computer-readable storage media 724 is a physical or tangible storage device used to store program instructions 718 rather than a medium that propagates or transmits program instructions 718. Computer-readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 718 can be transferred to data processing system 700 using a computer-readable signal media. The computer-readable signal media are signals and can be, for example, a propagated data signal containing program instructions 718. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 720” can be singular or plural. For example, program instructions 718 can be located in computer-readable media 720 in the form of a single storage device or system. In another example, program instructions 718 can be located in computer-readable media 720 that is distributed in multiple data processing systems. In other words, some instructions in program instructions 718 can be located in one data processing system while other instructions in program instructions 718 can be located in one data processing system. For example, a portion of program instructions 718 can be located in computer-readable media 720 in a server computer while another portion of program instructions 718 can be located in computer-readable media 720 located in a set of client computers.

The different components illustrated for data processing system 700 are not meant to provide architectural limitations to the manner in which different embodiments can be implemented. In some illustrative examples, one or more of the components may be incorporated in or otherwise form a portion of another component. For example, memory 706, or portions thereof, may be incorporated in processor unit 704 in some illustrative examples. The different illustrative embodiments can be implemented in a data processing system including components in addition to or in place of those illustrated for data processing system 700. Other components shown in FIG. 7 can be varied from the illustrative examples shown. The different embodiments can be implemented using any hardware device or system capable of running program instructions 718.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for transforming a natural language description to a target query language for performing a cybersecurity task, the computer implemented method comprising:
receiving, by a processor set, a request comprising a natural language description of the cybersecurity task;
converting, by the processor set using a machine learning model, the natural language description of the cybersecurity task into a graph, wherein the graph is generated based on an interlingual query language that defines node types for the graph;
translating, by the processor set using a compiler, the graph to a cybersecurity query in the target query language, wherein the compiler is developed to understand syntax of both the interlingual query language and the target query language; and
performing, by the processor set, the cybersecurity task using the cybersecurity query on a cybersecurity platform that supports the target query language.

2. The computer implemented method of claim 1, wherein the machine learning model is prompt-tuned or fine-tuned for the interlingual query language.

3. The computer implemented method of claim 1, wherein the node types for nodes in the graph are abstracted based on a number of query languages comprising the target query language.

4. The computer implemented method of claim 1, wherein a standard cybersecurity telemetry schema is used for object and attribute representation by the interlingual query language.

5. The computer implemented method of claim 1, wherein nodes for the graph represent at least one of query stages, data values, query functions, query object, and wherein edges for the graph represent query structure.

6. The computer implemented method of claim 1, wherein the compiler is paired with entity and attribute mapping from standardized schema to the cybersecurity platform for ensuring operation of the cybersecurity query in the cybersecurity platform.

7. The computer implemented method of claim 1, further comprises:
performing, by the processor set using the compiler, grammar checking, optimization, and security policy enforcement for the cybersecurity query when generating the cybersecurity query for the cybersecurity platform.

8. A computer system for transforming natural language to a target query language for performing a cybersecurity task, comprising:
a processor set;
a set of one or more computer-readable storage media; and
program instructions stored on the set of one or more storage media to cause the processor set to perform operations comprising:
receiving a request comprises natural language description of the cybersecurity task;
converting the natural language description of the cybersecurity task into a graph using a machine learning model, wherein the graph is generated based on an interlingual query language that defines node types for the graph;
translating the graph to a cybersecurity query in the target query language using a compiler, wherein the compiler is developed to understand syntax of both the interlingual query language and the target query language; and
performing the cybersecurity task using the cybersecurity query on a cybersecurity platform that supports the target query language.

9. The computer system of claim 8, wherein the machine learning model is prompt-tuned or fine-tuned for the interlingual query language.

10. The computer system of claim 8, wherein node types for nodes in the graph are abstracted based on a number of query languages comprising the target query language.

11. The computer system of claim 8, wherein a standard cybersecurity telemetry schema is used for object and attribute representation by the interlingual query language.

12. The computer system of claim 8, wherein nodes for the graph represent at least one of query stages, data values, query functions, query object, and wherein edges for the graph represent query structure.

13. The computer system of claim 8, wherein the compiler is paired with entity and attribute mapping from standardized schema to the cybersecurity platform for ensuring operation of the cybersecurity query in the cybersecurity platform.

14. The computer system of claim 8, wherein the operations further comprise:
performing grammar checking, optimization, and security policy enforcement for the cybersecurity query using the compiler when generating the cybersecurity query for the cybersecurity platform.

15. A computer program product for transforming natural language to a target query language for performing a cybersecurity task, comprising:
a set of one or more computer-readable storage media;
program instructions stored in the set of one or more computer-readable storage media to perform operations comprising:
receiving, by a processor set, a request comprising natural language description of the cybersecurity task;
converting, by the processor set using a machine learning model, the natural language description of the cybersecurity task into a graph, wherein the graph is generated based on an interlingual query language that defines node types for the graph;
translating, by the processor set using a compiler, the graph to a cybersecurity query in the target query language, wherein the compiler is developed to understand syntax of both the interlingual query language and the target query language; and
performing, by the processor set, the cybersecurity task using the cybersecurity query on a cybersecurity platform that supports the target query language.

16. The computer program product of claim 15, wherein the machine learning model is prompt-tuned or fine-tuned for the interlingual query language.

17. The computer program product of claim 15, wherein node types for nodes in the graph are abstracted based on a number of query languages comprising the target query language.

18. The computer program product of claim 15, wherein a standard cybersecurity telemetry schema is used for object and attribute representation by the interlingual query language.

19. The computer program product of claim 15, wherein nodes for the graph represent at least one of query stages, data values, query functions, query object, and wherein edges for the graph represent query structure.

20. The computer program product of claim 15, wherein the compiler is paired with entity and attribute mapping from standardized schema to the cybersecurity platform for ensuring operation of the cybersecurity query in the cybersecurity platform.
